(19) United States
(12) Patent Application Publication
(10) Pub. No.: US 2023/0196933 A1
(43) Pub. Date: Jun. 22, 2023

(54) VIDEO-BASED TRAINING ORGANIZATION SYSTEM AND METHOD OF USE THEREOF

(71) Applicant: Tatiana Jabbour, Saint-Laurent (CA)

(72) Inventor: Tatiana Jabbour, Saint-Laurent (CA)

(21) Appl. No.: 18/066,470

(22) Filed: Dec. 15, 2022

Related U.S. Application Data
(60) Provisional application No. 63/265,518, filed on Dec. 16, 2021.

(51) Int. Cl. G09B 5/06

(52) U.S. Cl. CPC G09B 5/065

(57) ABSTRACT

A computing device configured to generate a video-based training program for transmission to one or more client computing devices; it has a processor; memory; program code that, when executed by the processor, causes the processor to receive and store a plurality of videos from a training specialist computing device, wherein each of the plurality of videos includes a video identifier; receive training program values; generate a training program from the training program values including permissions to access the one or more videos of the plurality of videos corresponding to the one or more identifiers; retrieve one or more contact values stored in the one or more profile data structures; and transmit the training program to the one or more client computing devices; a method of use thereof.

The present application claims priority from U.S. provisional patent application No. 63/265,518, filed on Dec. 16, 2021, incorporated herein by reference.

### TECHNICAL FIELD

The present disclosure relates to video management and storage, and more particularly to video management and storage for offering personalized training based on the videos.

### BACKGROUND

Due to the size of certain files, namely videos, transfer and availability of a large amount of videos becomes resource-intensive, and can restrict access to the videos for certain recipients or intended viewers of the videos.

This is the case, for instance, for a system offering remote physical training to users of the system, where the physical training is structured through the use of the videos.

Due to the space and processing restrictions of certain of these systems, these systems usually settle for producing generic training programs for these users with generic videos that are disseminated to the viewers, as the size of the videos restricts the number of videos that can be shared between the users. As such, the users are offered generic videos to guide their training regimen. The result is a training program that does not take into account the personal condition of each of the users, such as their overall strength, injuries, physical limitations.

As such, it would be advantageous to achieve a system for custom or curated video management that could remedy the limitations of current training application programs offering standard, generic videos to their users.

### SUMMARY

The present disclosure relates to a video-based training organization system configured to provide client users with videos that are adapted to their specific requirements, produced, selected and arranged at a training specialist computing device.

The videos are classified and stored remotely to reduce resource consumption. The videos can be retrieved and/or compiled by a training specialist to build a training program that is specific to the needs of the client users.

The training specialist manages, from a training specialist interface, a plurality of client user profiles, building the tailored and custom training program for each, and providing access to one or more videos that are fit to the personal requirements of the client. The training specialist generates the videos, at the training specialist computing device, that are stored on a remote server that classifies and manages the videos. The videos are associated with a training specialist profile data structure that is related to the training specialist computing device from which the videos were generated.

A broad aspect is a method of generating a video-based training program for transmission to one or more client computing devices, wherein values of the training program are set at a training specialist computing device corresponding to a training specialist profile data structure related to a plurality of client profile data structures, including one or more client profile data structures corresponding to the one or more client computing devices, managed at the training specialist computing device, comprising. The method includes receiving and storing in memory a plurality of videos from a training specialist computing device, wherein each of the plurality of videos includes a video identifier; receiving training program values, from the training specialist computing device, including a selection of at least one identifier of the one or more client computing devices that are to receive the video-based training program, the training program values including one or more identifiers of one or more videos of the plurality of videos; generating a training program from the training program values including permissions to access the one or more videos of the plurality of videos corresponding to the one or more identifiers; retrieving one or more contact values stored in the one or more profile data structures corresponding to the at least one identifier; and transmitting the training program to the one or more client computing devices, whereby the one or more client computing devices can access the one more videos of the training program through the permissions.

In some embodiments, the video identifier may include a label indicative of content of the video.

In some embodiments, the one or more contact values may include one or more email addresses.

In some embodiments, the one or more contact values may include one or more telephone numbers.

In some embodiments, the received videos may be analyzed to identify anatomical content found in the videos, and one or more labels identifying the anatomical content are generated and stored with the received videos.

In some embodiments, the permissions may include passwords.

In some embodiments, the method may include receiving from the training specialist computing device input to disable access of one of the one or more client computing devices to the training program; and modifying a permission value of the client profile data structure corresponding to the one or more client computing devices, preventing access to the training program.

In some embodiments, the modifying of the permission value may correspond to a deactivation of a client profile associated with the client profile data structure.

In some embodiments, each of the one or more videos may include metadata identifying the training specialist profile data structure related to the training specialist computing device that transmitted the video.

In some embodiments, the method may include generating a list of descriptors for the received plurality of videos, the list specific to the training specialist profile data structure related to the training specialist computing device that transmitted the plurality of videos, wherein the list may be transmitted to the training specialist computing device for enabling a selection of the one or more videos, the one or more identifiers of the training program values determined from the selection.

Another broad aspect is a computing device configured to generate a video-based training program for transmission to one or more client computing devices, wherein values of the training program are set at a training specialist computing device corresponding to a training specialist profile data structure related to a plurality of client profile data structures, including one or more client profile data structures corresponding to the one or more client computing devices, managed at the training specialist computing device, the computing device comprising a processor; memory; program code stored in the memory that, when executed by the processor, causes the processor to receive and store a plurality of videos from a training specialist computing device, wherein each of the plurality of videos includes a video identifier; receive training program values, from the training specialist computing device, including a selection of at least one identifier of the one or more client computing devices that are to receive the video-based training program, the training program values including one or more identifiers of one or more videos of the plurality of videos; generate a training program from the training program values including permissions to access the one or more videos of the plurality of videos corresponding to the one or more identifiers; retrieve one or more contact values stored in the one or more profile data structures corresponding to the at least one identifier; and transmit the training program to the one or more client computing devices, whereby the one or more client computing devices can access the one more videos of the training program through the permissions.

In some embodiments, the video identifier may include a label indicative of content of the video.

In some embodiments, the one or more contact values may include one or more email addresses.

In some embodiments, the one or more contact values may include one or more telephone numbers.

In some embodiments, the program, when executed by the processor, may further cause the processor to analyze the received videos to identify anatomical content found in the videos, and one or more labels identifying the anatomical content may be generated and stored with the received videos.

In some embodiments, the permissions may include passwords.

In some embodiments, the memory may include program code that, when executed by the processor, causes the processor to receive from the training specialist computing device input to disable access of one of the one or more client computing devices to the training program; and modify a permission value of the client profile data structure corresponding to the one or more client computing devices, preventing access to the training program.

In some embodiments, the modifying of the permission value may correspond to a deactivation of a client profile associated with the client profile data structure.

In some embodiments, each of the one or more videos may include metadata identifying the training specialist profile data structure related to the training specialist computing device that transmitted the video.

In some embodiments, the memory may further include program code that, when executed by the processor, causes the processor to generate a list of descriptors for the received plurality of videos, the list specific to the training specialist profile data structure related to the training specialist computing device that transmitted the plurality of videos, wherein the list is transmitted to the training specialist computing device for enabling a selection of the one or more videos, the one or more identifiers of the training program values determined from the selection.

Another broad aspect is a non-transitory storage medium comprising program code that, when executed by a processor, causes the processor to receive and store a plurality of videos from a training specialist computing device, wherein each of the plurality of videos includes a video identifier; receive training program values, from the training specialist computing device, including a selection of at least one identifier of the one or more client computing devices that are to receive the video-based training program, the training program values including one or more identifiers of one or more videos of the plurality of videos; generate a training program from the training program values including permissions to access the one or more videos of the plurality of videos corresponding to the one or more identifiers; retrieve one or more contact values stored in the one or more profile data structures corresponding to the at least one identifier; and transmit the training program to the one or more client computing devices, whereby the one or more client computing devices can access the one more videos of the training program through the permissions.

### BRIEF DESCRIPTION OF THE DRAWINGS

The invention will be better understood by way of the following detailed description of embodiments of the invention with reference to the appended drawings, in which:

FIG. 1 is a block diagram of an exemplary architecture for a video-based training organization system;

FIG. 2 is a block diagram of computing devices of the exemplary architecture for a training program architecture including the video-based training organization system;

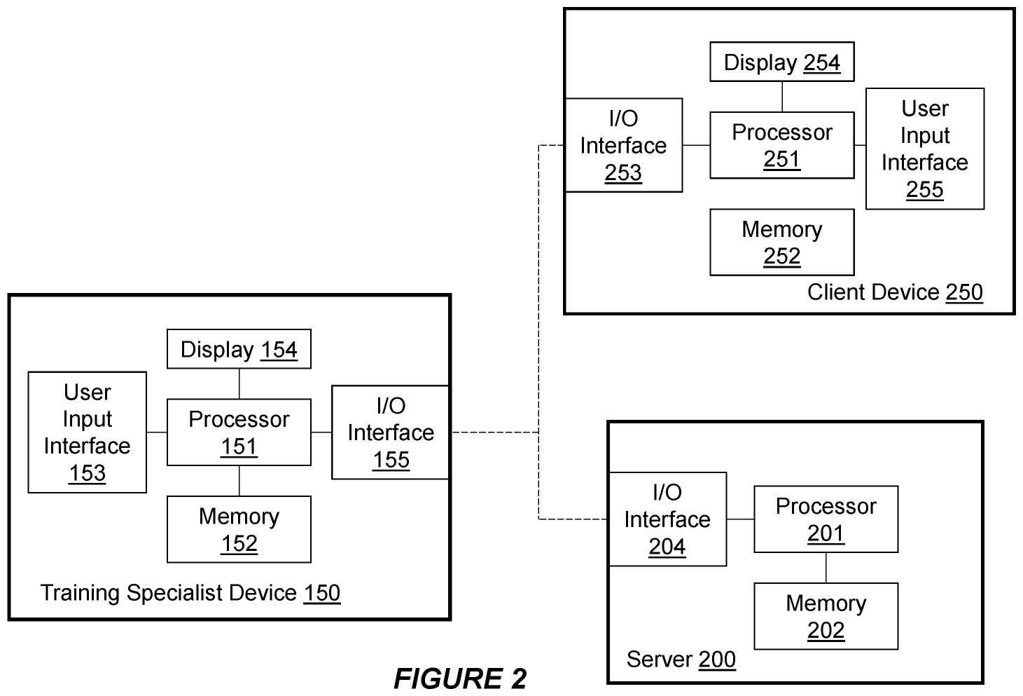

FIG. 3 is a block diagram of exemplary architecture of software stored on an exemplary server for organizing training videos;

FIG. 4 is a flowchart diagram of an exemplary method of generating a library of videos generated by a training specialist computing device; and

FIG. 5 is a flowchart diagram of an exemplary method of generating a training program for transmission to one or more client computing devices.

### DETAILED DESCRIPTION

The present disclosure relates to a system for video-based training program management. The system manages videos generated by the users (i.e. the training specialists at their respective training specialist computing devices) of the system in order to permit a larger volume of videos to be viewed from different computing devices, and to retrieve appropriate videos for viewing by the users through a video-classification system.

As a result, the system enables the creation of training programs, by the training specialist users, for the client users, that provides access to videos that are tailored to the specific requirements of each of the client users based, for instance, on their training goals, their general health, their physical limitations (e.g. resulting from an injury), etc.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

In the present disclosure, by “training specialist”, it is meant a professional that has an expertise in improving the physical condition of a person, such as through musculature or sports training, rehabilitation, stretching, etc. Exemplary training specialists include, but are not limited to, personal trainers, physiotherapists, sports coaches, yoga instructors, etc.

Therefore, a “training program”, as referred to herein, is a set of exercises tailored by the training specialist for one or more clients of same, for the purpose of musculature training, for physical rehabilitation, physical therapy, cardiovascular training, stretching, relaxation, etc.

A client, as referred to herein, may be a patient, e.g., when the training specialist is a medical professional, such as a physical therapist, wherein the training program has a medical purpose (e.g. physical rehabilitation following an injury, a medical condition, etc.)

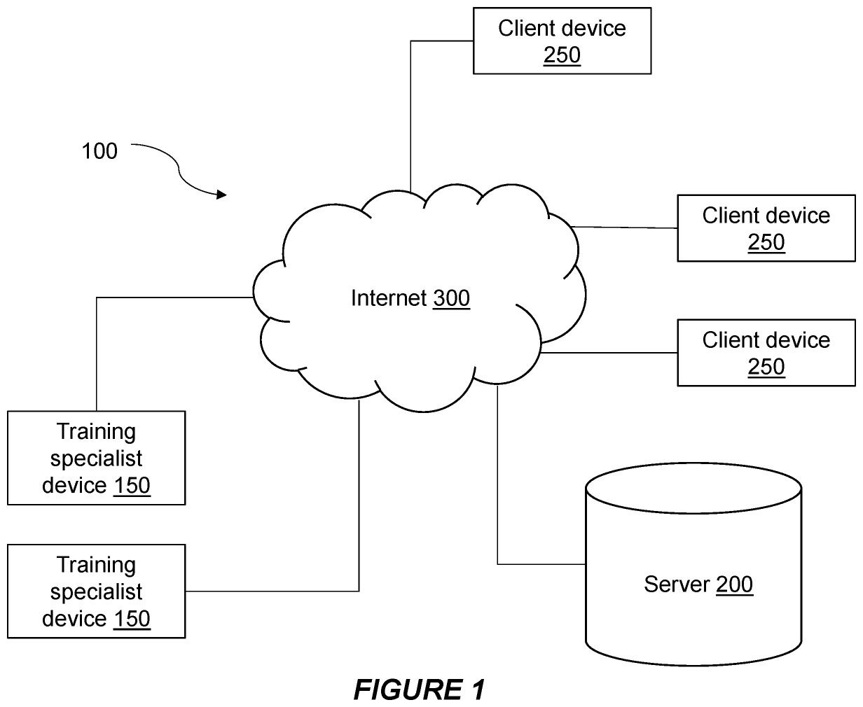

Reference is made to FIG. 1, illustrating exemplary architecture for an exemplary video-based training program system 100.

The system 100 includes a server 200, and is connected to one or more training specialist devices 100 and to a plurality of client devices 250 through the internet 300.

The server 200 has at least one processor 201, memory 202 and at least one input/output interface 204 for communication with an input/output interface 150 of one or more training specialist computing devices 150 and an input/output interface of one or more client computing devices 250, and/or an input/output interface 205 of the client device 200.

The server 200 may have an I/O interface 204 for communicating with the training specialist computing device(s) 150 and a separate I/O interface 204 for communicating with the client computing device(s) 250.

The processor 201 may be a general-purpose programmable processor. In this example, the processor 201 is shown as being unitary, but the processor may also be multicore, or distributed (e.g. a multi-processor).

The computer readable memory 202 stores program instructions and data used by the processor 201. The computer readable memory 202 may also store video files, metadata on the video files, user profile information, training program information, etc. The memory 202 may also store information regarding the training specialist computing device(s) 150 and the client computing device(s) 250, such as their IP addresses, and the profile data structure associated with each computing device. The memory 202 may be non-transitory. The computer readable memory 202, though shown as unitary for simplicity in the present example, may comprise multiple memory modules and/or caching. In particular, it may comprise several layers of memory such as a hard drive, external drive (e.g. SD card storage) or the like and a faster and smaller RAM module. The RAM module may store data and/or program code currently being, recently being or soon to be processed by the processor 201 as well as cache data and/or program code from a hard drive. A hard drive may store program code and be accessed to retrieve such code for execution by the processor 201 and may be accessed by the processor 201 to store and access data. The memory 202 may have a recycling architecture for storing, for instance, video files, profile data structures, training program information, where older data files are deleted when the memory 202 is full or near being full, or after the older data files have been stored in memory 202 for a certain time.

The I/O interface 204 is in communication with the processor 201. The I/O interface 204 may include a network interface and may be a wired or wireless interface for establishing a remote connection with, for example, a remote server, the training specialist computing device 150, the client computing device 250, etc. For instance, the I/O interface 204 may be an Ethernet port, a WAN port, a TCP port, etc.

The processor 201, the memory 202 and the I/O interfaces 204 may be linked via bus connections.

The client computing device 250 may be a remote computing device (i.e. client). The client device 250 is in communication with the I/O interface 204 of the server 200. The client computing device 250 has a processor 251, a memory 252, an I/O interface 253 that may be linked via bus connections. The client computing device 250 may have (or be connected to) any suitable user input interface 255, for example, such as a keyboard, a mouse, etc. The client computing device 250 may be a desktop computer, a laptop, a smartphone, a tablet, etc. The client computing device 250 has (or is connected to) a display 254 (e.g. a screen, a tactile display, etc.). The processor 251, the memory 252 and the I/O interface(s) 253 may be similar to the processor 201, the memory 202 and the I/O interface(s) 204, respectively.

A client application program may be stored in memory of the client computing device 250 that is associated with the server 200, the client application program providing the user with an interface to interact with the server 200 (e.g. for viewing the videos, for accessing a training program prepared from a training specialist computing device, etc.). In some examples, the client application program may synergize with other application programs stored on the client computing device (e.g. a map application program enabling a search function to ascertain a location of a training specialist on a map based on location information stored for the training specialist in the training specialist profile data structure; an application program for accessing the camera hardware of the phone, an application program for enabling a messaging function or chat function between users).

The training specialist computing device 150 may be a remote computing device (i.e. client). The training specialist device 150 is in communication with the I/O interface 204 of the server 200. The training specialist computing device 150 has a processor 151, a memory 152, an I/O interface 155 that may be linked via bus connections. The training specialist computing device 150 may have (or be connected to) any suitable user input interface 153, for example, such as a keyboard, a mouse, etc. The training specialist computing device 150 may be a desktop computer, a laptop, a smartphone, a tablet, etc. The training specialist computing device 150 has (or is connected to) a display 154 (e.g. a screen, a tactile display, etc.). The processor 151, the memory 152 and the I/O interface(s) 155 may be similar to the processor 201, the memory 202 and the I/O interface(s) 204, respectively.

A client application program may be stored in memory of the training specialist computing device 150 that is associated with the server 200, the client application program providing the user with an interface to interact with the server 200 (e.g. upload videos for storage at the remote server 200, for entering training program values for generating a training program for one or more client users corresponding to their client profile data structures, etc.).

As such, the architecture described herein may enable the implementation of one or more accessory features to improve the transmission of information between the client computing devices and the training specialist computing devices. Such features include, but are not limited to, a messaging system between a client computing device associated with a client computing profile data structure related to a training specialist profile data structure, and the training specialist computing device associated with the training specialist profile data structure (e.g. for transmitting comments, updates, progress reports, etc. on the training program). A real-time video communication feature may also be implemented between a client computing device associated with a client computing profile data structure related to a training specialist profile data structure, and the training specialist computing device associated with the training specialist profile data structure. This may enable a real-time training session offered from the training specialist computing device to the client computing device, through real-time video communication.

In some embodiments, another feature may be a notification system managed at the training specialist computing device (e.g. where the parameters of the notification setup may be stored on the training specialist profile data structure in association with one or more client profile data structures associated with the client computing devices to which the notifications are to be transmitted; or stored on the corresponding client profile data structure). Exemplary notifications may include, but are not limited to, encouraging messages, reminders to complete the training program of an exemplary exercise, etc.

Exemplary Software Architecture for Training Organization:

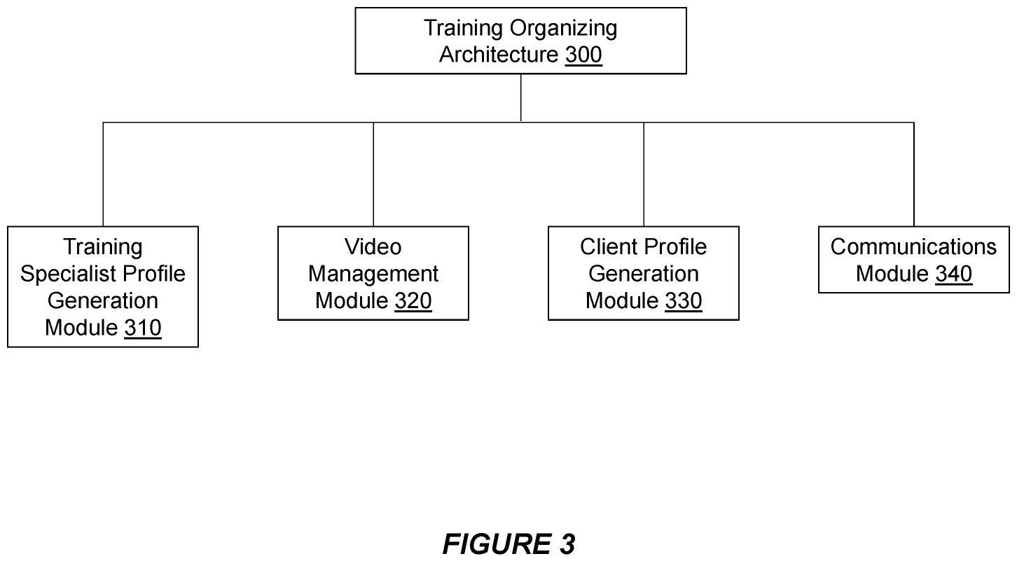

Reference is now made to FIG. 3, illustrating exemplary software architecture for training organization 300 that may be stored, e.g., in memory 202 of server 200.

The training organizing architecture 300 includes a training specialist profile generation module 310, a video management module 320, a client profile generation module 330 and a communication module 340.

The training specialist profile generation module 310 includes program code that, when executed by the processor, causes the processor to generate, manage access to, and remove training specialist profiles corresponding to training specialist profile data structures stored in memory. The training specialist profile generation module 310 receives a request from a computing device to generate a training specialist profile, and generates a training specialist profile data structure from the information provided with the request. An authorization may also be verified (e.g. verification that the request is associated with an account with up-to-date payment). The training specialist profile generation module 310 may cause the populating or creation of a graphical user interface on the requesting computing device 150 from which a training specialist may interact as explained herein. The training specialist profile generation module 310 may also cause the termination of an account based, e.g., on a request for same received from the computing device 150 associated with the training specialist profile data structure.

The training specialist profile generation module 310 enters the data values of the training specialist profile data structure based from input and information received from the training specialist computing device that has initiated the creation of a training specialist profile. The data values may include information for identifying the training specialist, such as their name, gender, location, training experience, etc. The data values may include an IP address of the computing device associated with the training specialist profile data structure, payment details for the corresponding training specialist (e.g. credit card information), a time stamp indicative of the time of creation of the training specialist profile data structure, etc.

When a video is received from a training specialist computing device 150, associated with a training specialist profile data structure, the training specialist profile generation module 310 calls the video management module 320.

The video management module 320 includes program code that, when executed by the processor, causes the processor to receive a video from a training specialist computing device 150, where the video includes metadata indicating that the computing device is the source of the video (e.g. identifier, IP address, etc.) as well as the training specialist profile data structure associated with the computing device 150 that transmitted the video. The video management module 320 may equally receive one or more labels, e.g. generated at the training specialist device 150, indicative of the content of the video (e.g. the labels may be pre-defined, where the training specialist selects, using the graphical user interface appearing on the computing device 150, the appropriate labels). In some embodiments, the video management module 320 may include a video analysis functionality, such as object recognition, to analyze the video and determine the content of the video, generating appropriate labels as a result. For instance, the video analysis may determine anatomical parts of a human body, as objects, that appear in the video. For instance, the video analysis software may identify the presence of an arm for a given duration of the video, a leg for a given duration of the video, etc. The video analysis software may then compare the time values for each of the identified anatomical objects, and generate a label for the body part that appears the most prevalently in the video (thereby concluding that the video pertains to the body part). The video analysis software may also analyze the sound of the video to identify key words that are indicative of the nature of the video (e.g. references to the word forearm being indicative of an exercise targeting the forearm), the labels generated as a function of the analysis of the sound.

In some embodiments, the video may also include metadata defining one or more permissions for one or more client computing devices 250. The permissions may include, e.g. a password, an IP address, a client profile data structure identifier, identifying one or more client computing devices that can have access to the video. Access is granted if the client computing device 250, requesting access to the video, is given the necessary permission (e.g. possesses the requisite credentials). Additionally, the video may be accessed by a training specialist computing device 250 that is tied to the training specialist profile data structure that originated the video, but may deny access to other training specialist computing devices 250. In some examples, the permissions to view one or more videos stored in memory may be granted once a training program has been generated, where the client computing devices do not have access to the videos until the training program has been generated, the training program including permissions (e.g. passcodes, addresses) for accessing the videos with identifiers that are integrated to the training program.

The client profile generation module 330 includes program code that, when executed by the processor, causes the processor to generate one or more client profile data structures that are related to a training specialist profile data structure, where access to, and the activity of the one or more client profile data structures, can be managed from a user interface associated with the training specialist profile data structure. The client profile generation module 330 receives input from the training specialist profile generation module 310 to generate, or deactivate, the one or more client profile data structures. The client profile generation module 330 receives input from one or more client computing device on which an interface corresponding to a client profile data structure is displayed, and applies one or more changes to the client profile data structure as a result of the input. Exemplary input may be to add information on the client, such as age, weight, height, gender physical disabilities, etc., feedback relating to the training program (e.g. a value indicative of the efficacy of the training program, completion of one or more exercises), comments for transmission to the training specialist computing device, etc. The client profile generation module 330 also receives one or more permission commands from the video management module 320, following input received from a training specialist computing device, to provide access to one or more videos generated at the training specialist computing device. In response, the client profile generation module 330 enables access to the client computing device associated with the appropriate client profile data structure, such as by changing a value in the client profile data structure associated with access, stored in the client profile data structure an encryption key or password for enabling viewing of one or more videos, etc. In some examples, the client profile generation module 330 may instead retrieve or generate addresses for each of the videos that are for transmission to the client computing devices associated with client profile data structures that are to have access to the videos. Access may then be made to the videos from the client computing devices through use of the address (e.g. a link providing access to a given video once selected).

The communication module 340 includes program code that, when executed by the processor, causes the processor to receive input from one or more training specialist computing devices and one or more client computing devices, processes the input and generates messages for one or more recipient computing devices as a function of the message received. For instance, the communications module 340 may receive a message from a training specialist computing device destined to a client with a client profile data structure. The communications module 340 generates a query to determine a location (e.g. IP address) of a client computing device corresponding to the destined client profile data structure, and transmits a message to same. The communications module 340 may also modify the relevant profile data structure to associate the message with the relevant profile (e.g. such that the message can be viewed using a computing device associated wit the profile data structure). In some examples, the communications module 340 may include a training program submodule that includes program code that, when executed by the processor, causes the processor to receive a request from a training specialist computing device to generate a training program, in some cases transmit a query to the training specialist computing device to provide additional information for generating a training program, including identifications for one or more videos to be associated with the training program, and generates the training program, for transmission to the client computing device, based on the input received from the training specialist computing device.

Exemplary Method of Populating a Library of Videos for Personal Training:

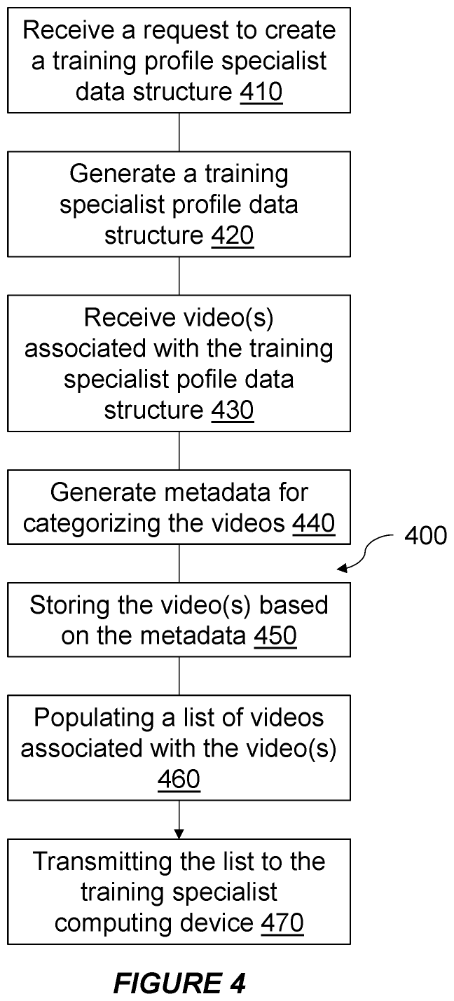

Reference is now made to FIG. 4, illustrating an exemplary method 400 of populating a library of videos for personal training. For purposes of illustration, reference will be made to system 100 and software architecture 300. However, it will be understood that any system and/or software may be used in accordance with the present teachings.

A request is received at step 410 at the server to create a training specialist profile data structure (e.g. a request from a training specialist computing device to create a new training specialist profile).

The training specialist profile data structure is created at step 420 based on information received from the training specialist computing device on the training specialist, such as the name of the training specialist, the qualifications of the training specialist, the location, gender, etc. of the training specialist, an image of the training specialist, etc. The server may also receive input to create one or more client profile data structures. The creation of one or more client profile data structures is initiated from input received from the training specialist computing device associated with an active training specialist profile data structure. Once the input is received by the server to create the one or more client profile data structures (e.g. a selection at the training specialist computing device of a subscription model for a certain number of client profile data structures that can be managed from the training specialist computing device of the training specialist profile data structure), the server generates the one or more client profile data structures. A notification may be transmitted to each of the one or more client computing devices (e.g. to an email address or telephone number, or to a client application program running on the client computing device) associated with the client profile data structure providing them with access (e.g. login information) to an interface corresponding to the client profile data structure. From that interface, a client can access a training program prepared from a training specialist computing device corresponding to the related training specialist computing device as explained herein.

Once the training specialist profile data structure is created, one or more videos may be received at the server from the training specialist computing device associated with the training specialist profile data structure at step 430. These videos may be generated from the training specialist computing device or uploaded at the training specialist computing device. The videos may be tailored to one or more clients of the training specialists, focusing on a specific exercise, a specific muscle group. The exercise captured in the video may be adapted to take into consideration a weakness or injury suffered by the client, or particular strength of a client, etc. As such, there may be several exercises relating to the same exercise, where each of the videos may be adapted to the specific condition of one or more clients.

The received videos may include metadata in the form of labels provided from the training specialist computing device. For instance, the labels may be that of a muscle group targeted in the video or of an injury or condition for which the video has been adapted for, identifier information of one or more client computing profile data structures that have access to the video, a timestamp indicative of the production date of the video, a length of the video, a size of the video, the IP address of the training specialist computing device that originated the video.

For instance, exemplary information that may be provided along with the video by the training specialist computing device may include, but is not limited to:
a title for the video;
a description for the video, including tips for the individual performing the exercise;
muscle groups involved;
injuries or difficulties of the client accommodated by the video;
a target kind of athlete that is the target audience for the video;
a number of repetitions;
a description of weight options;
a difficulty of the exercise;
rest between sets.

Some of the fields of information generated along with the video by the training specialist computing device may be updated by the training specialist computing device at a later date (e.g. number of repetitions, weight options, rest between sets, etc.), where this stored data associated with the video is modified as a function of the received updated information from the training specialist computing device. However, other fields of information provided with the initially generated video, used to generate the labels for searching through the databank of videos generated by a training specialist computing device, may not be eligible for modification (e.g. the muscle groups involved, the injuries or difficulties of the client accommodated by the video, etc.), in order to reduce the resource requirements imposed on the system when performing a search (where a hierarchy of labels may be provided to facilitate the searching through the videos—selecting one label of a first set of labels leads to a sub-category of labels depending on the selection).

Metadata may also be generated at the server 200 that further defines the video at step 440. For instance, the metadata may be the identity of the training specialist profile data structure that originated the video. The video may also be further analyzed at the server 200 to generate labels, as metadata, characterizing the content of the video, such as body parts involved in the video.

The videos are then stored in memory at step 450, along with its appropriate metadata. Retrieval of the video from memory may then be performed through analysis of the metadata associated to the videos.

In some embodiments, a list or directory of videos may also be populated at step 460, including, for instance, a title generated at the training specialist computing device for the video. The list may be specific to one training specialist profile data structure, or may be common to a plurality of training specialist profile data structures.

The list may be transmitted to the training specialist computing device at step 470, where a training specialist may select one or more videos from the list to associate with a training program for one or more clients, as explained herein, for generating a training program by selecting videos associated with the training program as training program values.

Exemplary Method of Generating a Training Program:

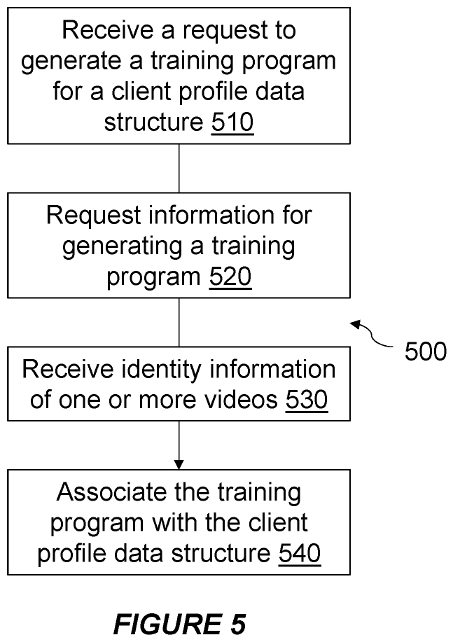

Reference is now made to FIG. 5, illustrating an exemplary method 500 of generating a training program for personal training. For purposes of illustration, reference will be made to system 100 and software architecture 300. However, it will be understood that any system and/or software may be used in accordance with the present teachings.

A notice is received that a training program generation is initiated at a training specialist computing device, associated with a training specialist profile data structure, at step 510. The notice may correspond to a training specialist selecting an option on the graphical user interface generated on the training specialist computing device to generate a training program.

A request or prompt is then generated for the training specialist computing device to provide information on the parameters of the training program at step 520. For instance, the request may be presented as a series of fields and options that can be filled in, selected by, a training specialist, appearing on the graphical user interface displayed on the training specialist computing device (e.g. through a client application program running on the training specialist computing device). The fields or options may be for providing a description of one or more exercises to be performed by the client, an identification of the number of repetitions, series for a given exercise, the muscle group involved. A field may be a selection of at least one of the one or more client profile data structures that are associated with the training specialist profile data structure, corresponding to the client to whom the training program is destined.

Amongst the information provided by the training specialist for generating the training program is a selection of one or more videos, e.g., generated by a training specialist computing device associated to the training specialist profile data structure with respect to which the training program is being generated, at step 530. The selection may be performed by the user scrolling or searching through a list of video identifiers, corresponding to videos stored in memory, at, e.g., the server 200. Selected videos may be associated with one or more exercises that have been identified by the training specialist. As these videos have been produced or uploaded by the training specialist, these videos are tailored to the specific exercises of the training program, and to the specific needs of the clients based on the selections made by the client, as stored in the client profile data structure.

In some embodiments, an amount of videos where permission is granted to more than one training specialist profile data structure (e.g. a base-level amount of videos) may also be selected by the training specialist. This may be a databank of videos that are accessible to each of the training specialists through the training specialist computing devices. These training videos may also be presented as possible videos to be selected when inputting the data for the training program to be generated (e.g. in the list of identifiers for available videos). Therefore, when a selection is made of videos for a training program, the selection may include both videos taken from this common databank (provided to at least a plurality of different training specialist computing devices), and from the videos that have been generated from the training specialist computing device associated with the training specialist profile data structure that has generated the video.

In some embodiments, the server may also receive from a training specialist computing device a video that is generated by the training specialist computing device for storage by the server as part of a databank of videos of which permission is granted with respect to each of the training specialist profile data structures.

In some examples, a training specialist computing device may generate an additional video that is added specifically for a training program, i.e. that is not first stored remotely by the server. The server may receive the generated video(s) along with the other information for generating the training program.

An option to view, at the training specialist computing device, prior to selecting a video for integration into a given training program. For instance, the training specialist may select a view option associated with a title or identifier of a video from the list of available videos that are available for selection, and managed by server 200. Once the view option is selected, the server 200 receives a request with an IP address of the requesting training specialist computing device, to view the video. A query to retrieve the corresponding video file is made to storage, the video file retrieved, and playback or streaming is enabled from the training specialist computing device.

In some embodiments, the videos may be presented with thumbnails, through the interface displayed on the training specialist computing device, that can provide the training specialist with more visual information for selecting the appropriate video.

A search through the videos uploaded at the training specialist computing device may also be performed through a word search entered by the training specialist at the training specialist computing device, where the word search generates a query to retrieve one or more videos with labels corresponding to the words of the search, the query analyzing the labels by parsing the characters of same, stored in the metadata of the videos. Identifiers corresponding to videos with labels matching the search words may be generated on the graphical user interface displayed on the training specialist computing device, for further selection by the training specialist when assembling the training program by setting the training program values (e.g. parameters for generating the training program, such as the name and description of the exercises, the repetitions for the exercises, the video(s) associated to each exercise, the identifiers of the one or more client profile data structures that are to receive the training program, etc.).

The search may also be organized in groupings of categories and sub-categories of labels (based on the labels associated with the videos), where the interface displayed on the training specialist computing device provides a series of categories for selection, and upon selection of a given category amongst the series of categories, a second selection of sub-categories, associated with the selected category, may be performed. For instance, a category may “exercise difficulty”, where the sub-category is “low”, “medium”, “high”. If a selection is made of “high”, then identifiers for videos with a label indicative of a high exercise difficulty level will be retrieved and displayed on the display of the training specialist computing device.

With the training program information provided as training program values, the training values are received at the server 200, the server generating the training program from the training program values.

The training program values are analyzed to identify the client profile data structure in association with which the training program is specific to at step 540. The training program may include an identifier of the client profile data structures made by the training specialist when providing input for the generation of the training program. The identifier may be analyzed, and then a query may be sent to memory storing the plurality of client profile data structures to retrieve an identifier of the client profile data structure, and contact information associated with the client profile data structure. The client profile data structure may also include a permission to view each of the videos associated with the training program that are in storage. In some embodiments, a path to access the video in storage may also be included in the data of the generated training program. As such, upon receipt of the training program at the client computing device, a selection input of a description of a specific video causes the playback of the video on the client computing device, retrieved from memory through the use of the path.

The training program details may also include different exercises depending on the day of the week, or the number of weeks the training program has been carried out.

As such, the client can access the training program tailored to the client by the training specialist, at the client computing device. Selection of a video through the graphical user interface displayed on the client computing device causes the playback of the corresponding video (e.g. through streaming). As the content and the destination of the training program is managed at the training specialist computing device, the training specialist can prepare a training program that is adapted to the needs of the client, as detailed in the data of the client stored in the client profile data structure.

Moreover, the training specialist can manage access of the one or more clients to the training program, through the client computing devices, by, for instance, ending access of one of the clients. In this example, input received at the server to end access for a client associated with an identifier for that client causes the generation of a query from the identifier to retrieve the corresponding client profile data structure. A value is then modified in the client profile data structure, corresponding to a denial of access. The profile data structure may also be deleted following receipt of input from the training specialist computing device to terminate the client.

In some examples, input may be received from the training specialist computing device to modify (e.g. add an exercise, include one or more new videos, change the repetitions on the video, etc.) or delete at least part of a training program that has already been transmitted to a client computing device associated with the training specialist profile data structure. The received input by the server includes an identifier related to the training program that has been generated, such that the server may perform the necessary modifications to the training program corresponding to the identifier.

The information on the training program may also be stored in memory by the server, e.g., with an identifier for the training program. As such, the training program corresponding to the identifier may be retrieved from memory when, e.g., the training program is to be modified. The modified training program information may then be stored in memory by the server.

In some examples, the client computing device may also generate feedback (e.g. receive input from the client) or a input a command indicative that the client has completed the training program, the input sent to the server, and in turn transmitted to the corresponding training specialist computing device, indicative that the client has completed an exercise of the training program, or the entire training program (e.g. provides the training specialist of the progress of the client in the execution of the training program).

In some embodiments, the application program interface enabled on the client computing device, for presenting the training program, may synergize with music playing software of the computing device (e.g. where a volume of the music played, or where the music may start or pause, depending on if audio—e.g. the training specialist is speaking in the video—is present in one of the videos of the training program, played on the client computing device).

Exemplary Client Profile Data Structure:

An exemplary client profile data structure in accordance with the present teachings is a collection of data values, and relationships between the data values, that defines characteristics, selections and permissions for a given client associated with the client profile data structure.

The client profile data structure includes a data value for the training specialist profile data structure to which the client profile data structure is related, as input to generate the client profile data structure is entered from the training specialist computing device. Some of the information may also be provided by the client computing device, e.g. upon receiving a notification to provide this information initiated from the training specialist computing device.

In some examples, the client profile data structure may include one or more permissions to access one or more videos generated by the training specialist computing device associated to training specialist profile data structure to which the client profile data structure is related.

The client profile data structure may include, but are not limited to data values for one of the following exemplary categories of information:
Name, address, telephone number, email of the client;
age of the client;
gender of the client;
weight with logging dates for when an input has been received by the client computing device;
injuries, difficulties or weaknesses of the client;
goals of the client;
time frame to achieve goals;
target muscle groups of the client.
image upload to view progress with date confirmation, uploaded at the client computing device.

Data of the client profile data structure may be modified through receipt of input from the graphical user interface displayed on the client computing device, or on the graphical user interface displayed on the training specialist computing device.

The client profile data structure may also include a value indicative of the activity of the client profile (i.e. if the client profile is active or if the client profile is deactivated). The activity of the client profile may be managed at the graphical user interface displayed on the training specialist computing device, where input may be received from the training specialist computing device to activate or deactivate a client profile data structure.

In some embodiments, permissions may be granted to the server to receive data for accessory devices used by the client (e.g. a FIDBIT™, a smartphone, a heart rate monitor, a blood pressure monitor, a pulse-oximeter, etc.), where the information may be transmitted, via the server, to the training specialist computing device, or stored in, with respect to, the client profile data structure.

Exemplary Training Specialist Profile Data Structure:

An exemplary training specialist profile data structure in accordance with the present teachings is a collection of data values, and relationships between the data values, that defines characteristics and selections for a given training specialist associated with the training specialist profile data structure.

The training specialist profile data structure may include data values on, but not limited to, the following exemplary characteristics of the training specialist (e.g. as inputted by the training specialist at the training specialist computing device, e.g. upon creation of a training specialist profile using a client application program running on the training specialist computing device):
specialty (e.g. field, related sports, etc.) of the training specialist;
category of training specialist (e.g. a coach, a trainer, a physical therapist, etc.)
description of training specialist;
name of the training specialist;
address of practice of the training specialist;
email address of the training specialist;
an image of the training specialist and/or the business of the training specialist;
education of the training specialist;
time availabilities of the training specialist.

The training specialist profile data structure may also include identifiers for one or more videos that have been generated at the training specialist computing device corresponding to the training specialist profile data structures.

The training specialist profile data structure may also include identifiers for one or more client profile data structure that are managed at the training specialist computing device, by the training specialist, corresponding to the training specialist profile data structure.

The training specialist profile data structure may also include authentication information (e.g. passcode) to allow a user to access, from a computing device, information of the training specialist profile data structure.

The data values of the training specialist profile data structure may also be modified at the training specialist computing device corresponding to the training specialist profile data structure.

The training specialist profile data structure may also include data on the type of subscription related to the training specialist profile data structure (selected by the training specialist using the training specialist computing device), where the selected type of subscription may permit the creation of a defined number of client profile data structures depending on the selected type of subscription.

In some embodiments, the training specialist profile data structure may include information on one or more availabilities of the training specialist (e.g. received at the server as input generated by selecting one or more time slots from a calendar). This availability information may be viewed and/or transmitted to the client computing device, e.g., for the client to establish a time to schedule a virtual meeting with the training specialist.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method of generating a video-based training program for transmission to one or more client computing devices, wherein values of the training program are set at a training specialist computing device corresponding to a training specialist profile data structure related to a plurality of client profile data structures, including one or more client profile data structures corresponding to the one or more client computing devices, managed at the training specialist computing device, comprising:
receiving and storing in memory a plurality of videos from a training specialist computing device, wherein each of the plurality of videos includes a video identifier;
receiving training program values, from the training specialist computing device, including a selection of at least one identifier of the one or more client computing devices that are to receive the video-based training program, the training program values including one or more identifiers of one or more videos of the plurality of videos;
generating a training program from the training program values including permissions to access the one or more videos of the plurality of videos corresponding to the one or more identifiers;
retrieving one or more contact values stored in the one or more profile data structures corresponding to the at least one identifier; and
transmitting the training program to the one or more client computing devices, whereby the one or more client computing devices can access the one more videos of the training program through the permissions.

2. The method as defined in claim 1, wherein the video identifier includes a label indicative of content of the video.

3. The method as defined in claim 1, wherein the one or more contact values include one or more email addresses.

4. The method as defined in claim 1, wherein the one or more contact values include one or more telephone numbers.

5. The method as defined in claim 1, wherein the received videos are analyzed to identify anatomical content found in the videos, and one or more labels identifying the anatomical content are generated and stored with the received videos.

6. The method as defined in claim 1, wherein the permissions include passwords.

7. The method as defined in claim 1, further comprising:
receiving from the training specialist computing device input to disable access of one of the one or more client computing devices to the training program; and
modifying a permission value of the client profile data structure corresponding to the one or more client computing devices, preventing access to the training program.

8. The method of claim 7, wherein the modifying of the permission value corresponds to a deactivation of a client profile associated with the client profile data structure.

9. The method as defined in claim 1, wherein each of the one or more videos comprises metadata identifying the training specialist profile data structure related to the training specialist computing device that transmitted the video.

10. The method as defined in claim 1, further comprising generating a list of descriptors for the received plurality of videos, the list specific to the training specialist profile data structure related to the training specialist computing device that transmitted the plurality of videos, wherein the list is transmitted to the training specialist computing device for enabling a selection of the one or more videos, the one or more identifiers of the training program values determined from the selection.

11. A computing device configured to generate a video-based training program for transmission to one or more client computing devices, wherein values of the training program are set at a training specialist computing device corresponding to a training specialist profile data structure related to a plurality of client profile data structures, including one or more client profile data structures corresponding to the one or more client computing devices, managed at the training specialist computing device, the computing device comprising:
a processor;
memory;
program code stored in the memory that, when executed by the processor, causes the processor to:
receive and store a plurality of videos from a training specialist computing device, wherein each of the plurality of videos includes a video identifier;
receive training program values, from the training specialist computing device, including a selection of at least one identifier of the one or more client computing devices that are to receive the video-based training program, the training program values including one or more identifiers of one or more videos of the plurality of videos;
generate a training program from the training program values including permissions to access the one or more videos of the plurality of videos corresponding to the one or more identifiers;
retrieve one or more contact values stored in the one or more profile data structures corresponding to the at least one identifier; and
transmit the training program to the one or more client computing devices, whereby the one or more client computing devices can access the one more videos of the training program through the permissions.

12. The computing device as defined in claim 11, wherein the video identifier includes a label indicative of content of the video.

13. The computing device as defined in claim 11, wherein the one or more contact values include one or more email addresses.

14. The computing device as defined in claim 11, wherein the one or more contact values include one or more telephone numbers.

15. The computing device as defined in claim 11, wherein the program, when executed by the processor, further causes the processor to analyze the received videos to identify anatomical content found in the videos, and one or more labels identifying the anatomical content are generated and stored with the received videos.

16. The computing device as defined in claim 11, wherein the memory further includes program code that, when executed by the processor, causes the processor to:
receive from the training specialist computing device input to disable access of one of the one or more client computing devices to the training program; and
modify a permission value of the client profile data structure corresponding to the one or more client computing devices, preventing access to the training program.

17. The computing device of claim 16, wherein the modifying of the permission value corresponds to a deactivation of a client profile associated with the client profile data structure.

18. The computing device as defined in claim 11, wherein each of the one or more videos comprises metadata identifying the training specialist profile data structure related to the training specialist computing device that transmitted the video.

19. The computing device as defined in claim 11, wherein the memory further includes program code that, when executed by the processor, causes the processor to generate a list of descriptors for the received plurality of videos, the list specific to the training specialist profile data structure related to the training specialist computing device that transmitted the plurality of videos, wherein the list is transmitted to the training specialist computing device for enabling a selection of the one or more videos, the one or more identifiers of the training program values determined from the selection.

20. A non-transitory storage medium comprising program code that, when executed by a processor, causes the processor to:
receive and store a plurality of videos from a training specialist computing device, wherein each of the plurality of videos includes a video identifier;
receive training program values, from the training specialist computing device, including a selection of at least one identifier of the one or more client computing devices that are to receive the video-based training program, the training program values including one or more identifiers of one or more videos of the plurality of videos;
generate a training program from the training program values including permissions to access the one or more videos of the plurality of videos corresponding to the one or more identifiers;
retrieve one or more contact values stored in the one or more profile data structures corresponding to the at least one identifier; and
transmit the training program to the one or more client computing devices, whereby the one or more client computing devices can access the one more videos of the training program through the permissions.
